(19) United States
(12) Patent Application Publication
(10) Pub. No.: US 2024/0262289 A1
(43) Pub. Date: Aug. 8, 2024

(54) INFRARED ADDITIVE FOR AN EPOXY USED TO MAKE AN OPTIC FOR USE WITH LIGHT SENSORS

(71) Applicant: Gentex Corporation, Zeeland, MI (US)

(72) Inventors: Michael F. Lisowski, Holland, MI (US); Steven J. Veenman, Hudsonville, MI (US); Gary J. Dozeman, Zeeland, MI (US)

(21) Appl. No.: 18/434,235

(22) Filed: Feb. 6, 2024

Related U.S. Application Data
(60) Provisional application No. 63/443,894, filed on Feb. 7, 2023.

(51) Int. Cl. B60R 1/08; B60R 1/12

(52) U.S. Cl. CPC B60R 1/088; B60R 1/12; B60R 2001/1223

(57) ABSTRACT

A rearview assembly includes a housing with a dimmable reflective element and a glare sensor assembly. The glare sensor assembly includes a circuit board disposed within the housing, a light sensor in communication with the circuit board, and a primary optic proximate to and in communication with the light sensor. The primary optic is a substantially homogeneous cured epoxy that has an infrared blocker dye with a green tint that at least partially blocks infrared light from being exposed to the light sensor. A secondary optic is configured to receive and direct light to the primary optic. The primary optic is disposed between the circuit board and the secondary optic.

### CROSS-REFERENCE TO RELATED APPLICATION

This application claims priority to and the benefit under 35 U.S.C. § 119(e) of U.S. Provisional Application No. 63/443,894, filed on Feb. 7, 2023, entitled “INFRARED ADDITIVE FOR AN EPOXY USED TO MAKE AN OPTIC FOR USE WITH LIGHT SENSORS,” the disclosure of which is hereby incorporated herein by reference in its entirety.

### FIELD OF THE DISCLOSURE

The present disclosure generally relates to an infrared additive for an epoxy, and more particularly to an infrared additive for epoxy used to make an optic for use with light sensors.

### SUMMARY OF THE DISCLOSURE

According to one aspect of the present disclosure, a rearview assembly includes a housing with a dimmable reflective element and a glare sensor assembly. The glare sensor assembly includes a circuit board disposed within the housing, a light sensor in communication with the circuit board, and a primary optic proximate to and in communication with the light sensor. The primary optic is a substantially homogeneous cured epoxy that has an infrared blocker dye with a green tint that at least partially blocks infrared light from being exposed to the light sensor. A secondary optic is configured to receive and direct light to the primary optic. The primary optic is disposed between the circuit board and the secondary optic.

According to a second aspect of the present disclosure, a rearview assembly includes a housing with a dimmable reflective element and a glare sensor assembly. The glare sensor assembly includes a circuit board disposed within the housing, a light sensor in communication with the circuit board, and a primary optic proximate to and in communication with the light sensor. The primary optic is a substantially homogeneous cured epoxy that at least partially blocks infrared light from being exposed to the light sensor. A secondary optic is configured to receive and direct light to the primary optic.

According to still another aspect of the present disclosure, a rearview assembly includes a housing, a circuit board disposed within the housing, and a glare sensor assembly disposed within the housing. The glare sensor assembly includes a light sensor in communication with the circuit board and an optic in communication with the light sensor. The optic is formed from an infrared blocker dye and a cured epoxy. The optic may include a primary optic and a secondary optic. The secondary optic may be configured to receive and direct light to the primary optic.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a top, rear side elevational view of an interior cabin of a vehicle with a rearview mirror assembly of the present disclosure;

FIG. 2 is a top perspective view of a rearview mirror assembly of the present disclosure;

FIG. 3 is a top perspective exploded view of a rearview mirror assembly of the present disclosure; and

FIG. 4 is an enlarged top perspective view of a glare sensor assembly of a rearview mirror assembly of the present disclosure;

FIG. 5 is an enlarged top perspective view of a glare sensor assembly of a rearview mirror assembly of the present disclosure;

FIG. 6 is a front perspective view of a glare sensor assembly of the present disclosure;

FIG. 7 is a rear perspective view of a glare sensor assembly of the present disclosure; and

FIG. 8 is a block diagram that illustrates a process to form an epoxy with an infrared additive for use with optics for light sensors.

### DETAILED DESCRIPTION

The present illustrated embodiments reside primarily in combinations of method steps and apparatus components related to an infrared additive for an epoxy used to make an optic for use with light sensors. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

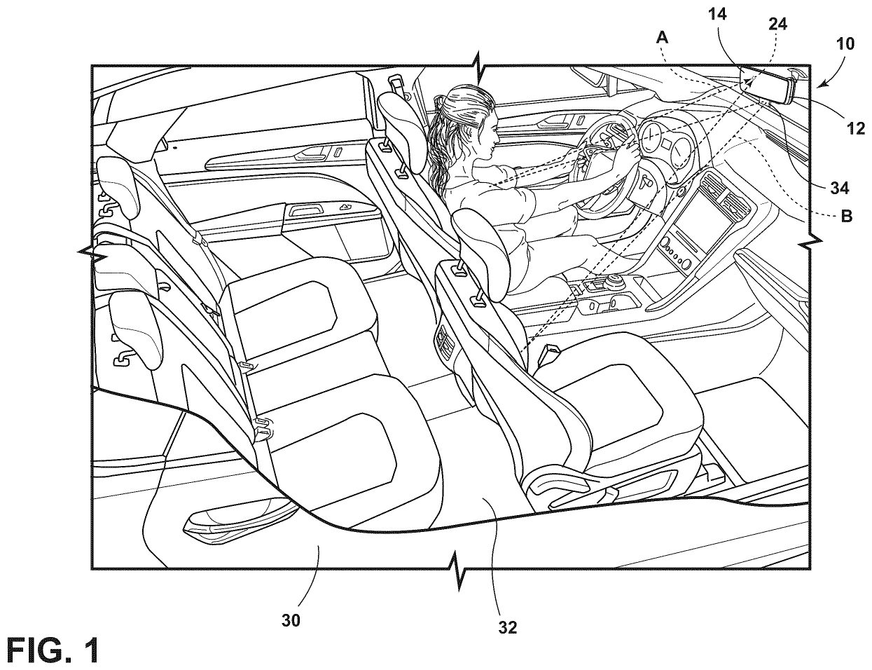

For purposes of description herein, the terms “upper,” “lower,” “right,” “left,” “rear,” “front,” “vertical,” “horizontal,” and derivatives thereof, shall relate to the disclosure as oriented in FIG. 1. Unless stated otherwise, the term “front” shall refer to a surface of the device closest to an intended viewer, and the term “rear” shall refer to a surface of the device furthest from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

Referring to FIGS. 1-5, reference numeral 10 generally designates a rearview assembly that includes a housing 12 with a dimmable reflective element 14 and a glare sensor assembly 16. The glare sensor assembly 16 includes a circuit board 18 that is disposed within the housing 12. The glare sensor assembly 16 also includes a light sensor 20 that is in communication with the circuit board 18 and a primary optic 22 that is proximate to and in communication with the light sensor 20. The primary optic 22 is a substantially homogeneous cured epoxy mixture that at least partially blocks infrared light from being exposed to the light sensor 20. A secondary optic 24 may be disposed behind the dimmable reflective element 14 of an electro-optic assembly. The secondary optic 24 receives and directs light to the primary optic 22.

With reference now to FIG. 1, a vehicle 30 defining an interior cabin 32 includes the rearview assembly 10. The rearview assembly 10 incorporates an interior cabin monitoring system 34 including, but not limited to a driver monitoring system or an in-cabin monitoring system. The rearview assembly 10 also includes the dimmable reflective element 14, which may be in the form of an electro-optic assembly or an electrochromic assembly and which is supported between the housing 12 and a bezel 38. However, it is also contemplated that rearview assembly 10 may be free of the bezel 38 such that the dimmable reflective element 14 couples with the housing 12 and is supported therein. The circuit board 18, which may be a printed circuit board (PCB), is disposed within the housing 12 and generally supports the glare sensor assembly 16. It is contemplated that the PCB 18 may include a single PCB or multiple PCBs disposed at various locations within the housing 12. Additionally, it will be noted that the glare sensor assembly 16 may be spaced from the PCB 18 and need not be directly coupled thereto.

In some instances, the use of the interior cabin monitoring system 34 may result in unintentional dimming of the dimmable reflective element 14 as a consequence of the glare sensor assembly 16 being exposed to and detecting infrared (IR) light emitted by the interior cabin monitoring system 34. As shown in FIG. 1, infrared light rays A and B are emitted by the interior cabin monitoring system 34. The infrared light rays A and B are then captured by a sensor of the interior cabin monitoring system 34 that monitors in-cabin activity or events. However, the glare sensor assembly 16 may also capture IR light emitted by the interior cabin monitoring system 34 which may be detected as glare by a processor of the circuit board 18, thereby resulting in the dimmable reflective element 14 unintentionally darkening.

As shown in FIG. 1, the glare sensor assembly 16 of the rearview assembly 10 faces into the interior cabin 32 of the vehicle 30 and thus is susceptible to exposure to infrared light when the interior cabin monitoring system 34 is in use. As previously noted, the glare sensor assembly 16 captures light through the primary optic 22, which may be a glare sensor lens adjacent to the light sensor 20. The secondary optic 24 may be an external lens that directs light to the primary optic 22. Alternatively, the secondary optic 24 may be a portion of the dimmable reflective element 14. In this case, the dimmable reflective element 14 provides a pathway for light to be received by the primary optic 22.

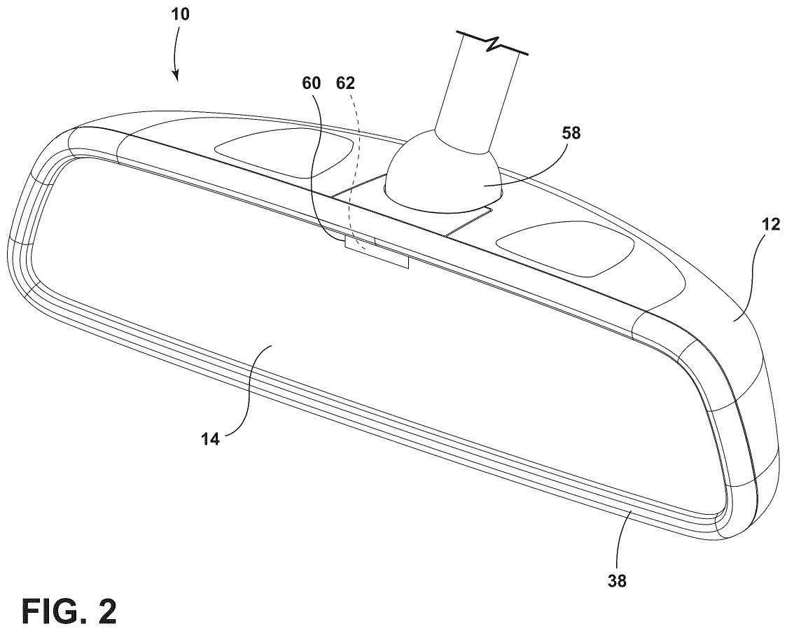

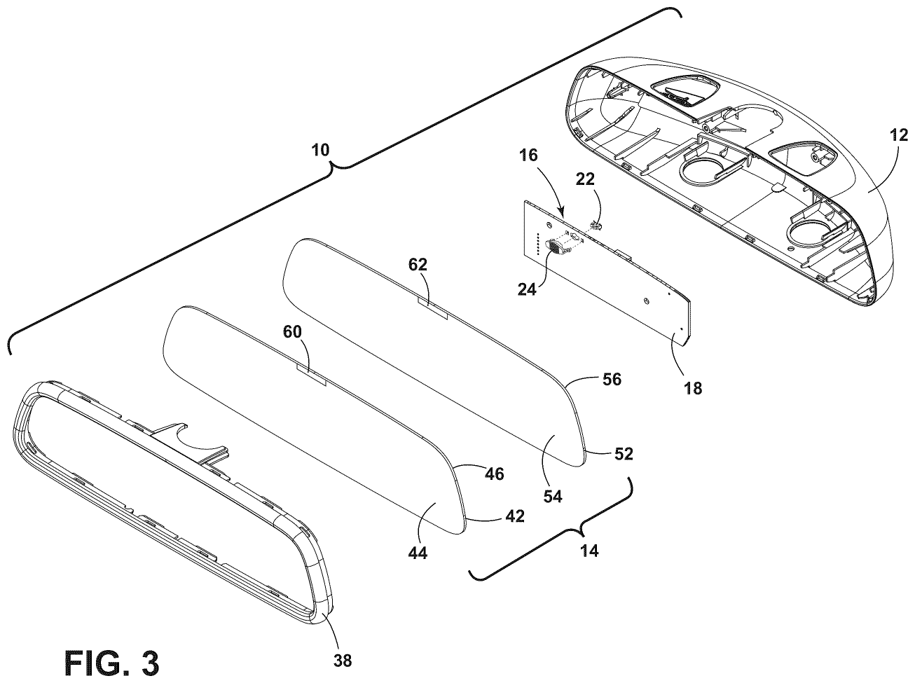

With reference now to FIGS. 2 and 3, in the illustrated construction, the glare sensor assembly 16 is disposed within the housing 12, behind the dimmable reflective element 14. As illustrated, the dimmable reflective element 14 is positioned between the bezel 38 and the printed circuit board 18. The bezel 38 is generally configured for engagement with the housing 12 and secures the dimmable reflective element 14 to the housing 12. However, as briefly discussed above, it is contemplated that the dimmable reflective element 14 may connect directly to the housing 12, thereby eliminating the need for the bezel 38. The dimmable reflective element 14 includes a front substrate 42 that has a first surface 44 and a second surface 46, as well as a rear substrate 52 that defines a third surface 54 and a fourth surface 56. Generally, a reflective coating is provided on the third surface 54 of the rear substrate 52, but can also be positioned on the fourth surface 56 of the rear substrate 52. An electro-optic medium is disposed between the second surface 46 and the third surface 54 and is configured to darken when glare is detected by the processor. The housing 12 is configured to receive various other components such as a ball mount 58 (FIG. 2), which may be a single ball mount or a dual ball mount. Notably, light from within the interior cabin 32 of the vehicle 30 accesses the glare sensor assembly 16 by penetrating through the dimmable reflective element 14 and, more specifically, through at least partially transparent portions 60, 62 of the front substrate 42 and rear substrate 52, respectively. In some instances the glare sensor assembly 16 may be disposed at a chin of the housing 12 or elsewhere relative to the housing 12 such that the glare sensor assembly 16 is not disposed behind the dimmable reflective element 14.

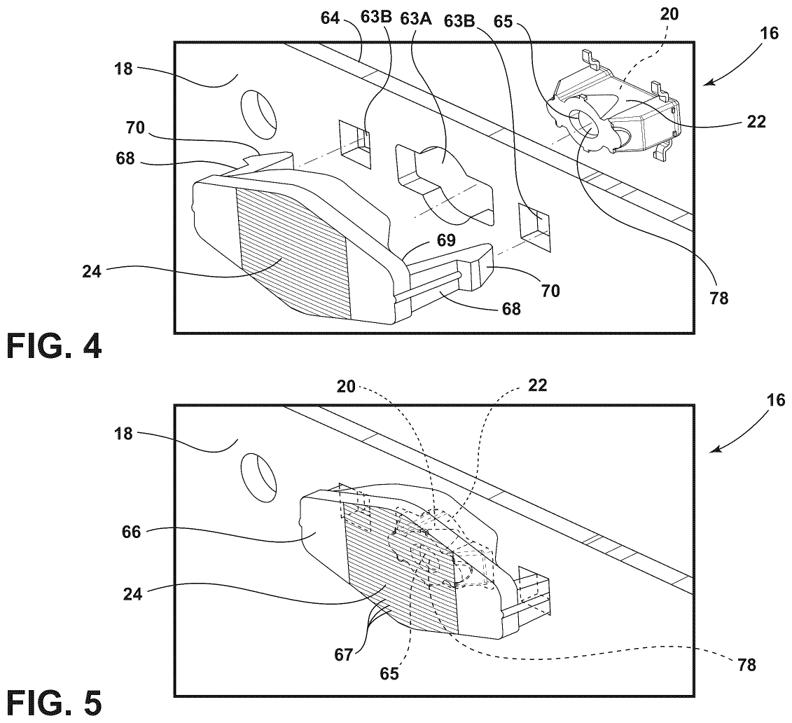

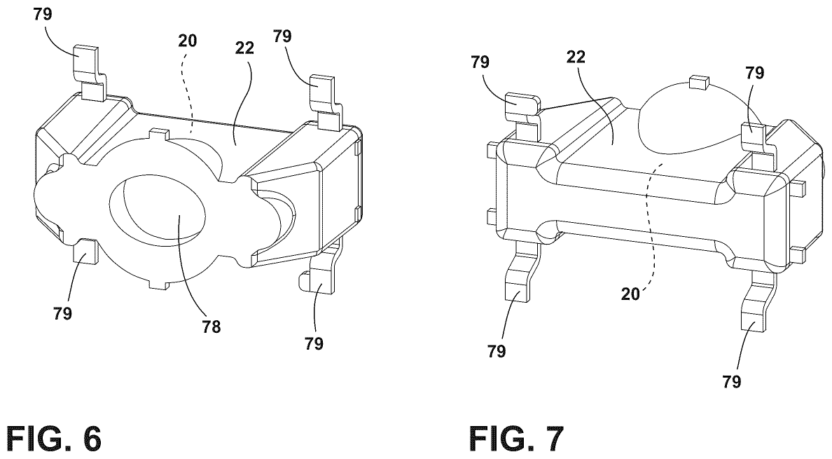

With reference now to FIGS. 4 and 5, in an effort to minimize higher exposure of IR light to the glare sensor assembly 16, the primary optic 22, or glare sensor lens, is provided with an infrared (IR) blocker that is configured to block up to 99.9999% of the infrared light that is exposed to the glare sensor assembly 16. In other configurations, it is contemplated that at least 99.99% of the IR light is blocked, and in other configurations at least 98% of the IR light is blocked. In still other configurations, it is contemplated that at least 95% of the IR light is blocked. The glare sensor lens, or the primary optic 22, is constructed from an epoxy, generally a two-part epoxy which includes a first part, such as a resin, and a second part, such as a hardener. As noted herein, the IR blocker is evenly dispersed within the two-part epoxy to form an IR blocking epoxy mixture 78. The IR blocker is generally in the form of an infrared blocker dye, possibly a dye with a visibly green tint. In some instances, the dye color may include a peak wavelength of between approximately 500 nm and 570 nm. The dye is provided during mixture of the first part and the second part of the epoxy together. The IR blocker does not hamper or otherwise diminish any physical or optical characteristics of the glare sensor lens, or the primary optic 22. In addition, the primary optic 22, maintains the same thermal characteristics such that excessive heating or cooling does not impact the practical use of the primary optic 22 by the glare sensor assembly 16. Construction of the glare sensor assembly 16 in this way results in improved performance of the dimmable reflective element 14 as a whole because infrared light no longer reaches the glare sensor assembly 16 and instead is blocked by the infrared blocker dye dispersed within the epoxy material that makes up the primary optic 22, or the glare sensor lens. Thus, unintentional dimming or brightening of the dimmable reflective element 14 is diminished or eliminated. The infrared blocker dye is generally soluble within the epoxy and uniformly dispersed throughout the primary optic 22, or the glare sensor lens. In addition, the infrared blocker dye does not compromise thermal stability of the primary optic 22, or the glare sensor lens, over time. As a result, infrared light between 800 nm and 1,000 nm is substantially or completely blocked while visible light in the range of 400 nm to 700 nm still reaches the glare sensor lens, or primary optic 22, such that optimal use of the glare sensor assembly 16 is maintained.

With reference again to FIGS. 4 and 5, the PCB 18 mayinclude a primary hole 63A configured to receive the primary optic 22 and mounting holes 63B configured to receive the secondary optic 24. In the illustrated construction, the primary optic 22 is inserted through a rear surface 64 of the PCB 18. The primary optic 22 mayinclude connection features that secure the primary optic 22 to the circuit board 18. In the illustrated construction, a central portion of the primary optic 22 includes an enlarged light receiving area, with a light receiving lens 65. It is generally contemplated that the primary optic 22 may be inserted into the primary hole 63A of the PCB 18 before the secondary optic 24 is connected with the circuit board 18. However, it is also contemplated that the primary optic 22 may be installed at the same time, or after the secondary optic 24 is installed or operably coupled with the circuit board 18. Is also contemplated that the secondary optic 24 mayinclude a receiving aperture configured to receive at least a portion of the primary optic 22. As illustrated in FIGS. 4 and 5, a front surface 66 of the secondary optic 24 mayinclude flutes 67 in the form of a series of parallel channels that horizontally traverse the front surface 66 of the secondary optic 24. The flutes 67 are configured to guide light to the primary optic 22 before reception into the light sensor 20. Stated differently, the front surface 66 of the secondary optic 24 mayinclude a fluted appearance and, in some instances, may have intersecting channels to provide a pillowed configuration on the front surface 66.

The secondary optic 24 may be coupled with the circuit board 18 in a variety of manners, including a snap-fit connection, as shown in FIGS. 4 and 5. In this instance, rearwardly-extending arms 68 protrude from a back surface 69 of the secondary optic 24. The rearwardly-extending arms 68 include outwardly protruding catches 70 designed to protrude through the mounting holes 63B and frictionally engage the rear surface 64 of the circuit board 18. It is generally contemplated that the rearwardly-extending arms 68 may be flexible so as to snap-fittingly engage the circuit board 18. It also contemplated that the secondary optic 24 may be adhered or fastened to the circuit board 18, and possibly to the primary optic 22 before, after, or during installation. The secondary optic 24 may be constructed of a variety of materials including glass or polymers. Regardless of the material used to construct the secondary optic 24, the optical portion of the secondary optic 24 may be at least partially translucent in some instances, and may be at least partially transparent in other instances. It will also be contemplated that the secondary optic 24 includes a substantially colorless body.

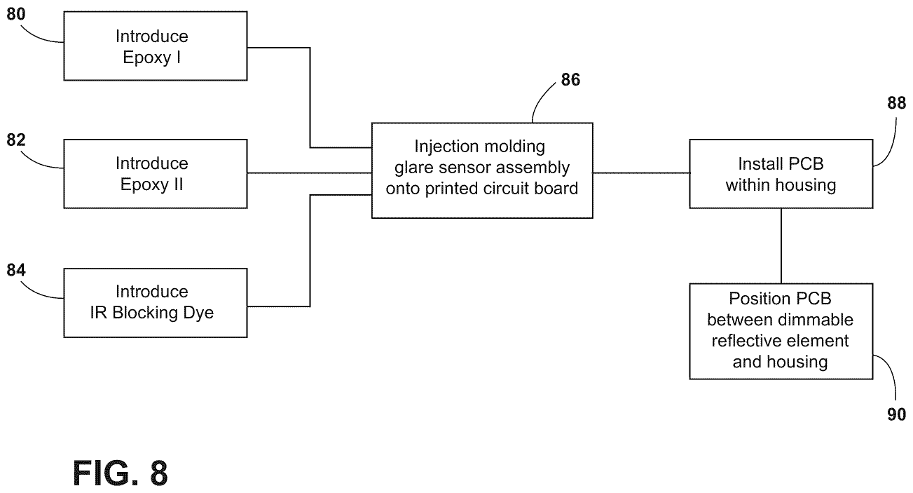

With reference now to FIG. 8, a first part (i.e., a resin) (step 80) and a second part (i.e., a hardener) (step 82) that will form the epoxy that is injection molded to form the primary optic 22 of the glare sensor assembly 16 are introduced. It is contemplated that the IR blocker may be separately introduced to the mixture (step 84). Alternatively, the IR blocker may be introduced with the first part of the epoxy before mixing with the second part of the epoxy, or may be mixed with the second part of the epoxy before mixing with the first part of the epoxy. Once the IR blocker, the first part of the epoxy, and the second part of the epoxy have been properly mixed such that the mixture is generally or completely homogeneous, the IR blocking epoxy mixture 78 is injection molded over a lead frame that provides metal connectors 79 to form the primary optic 22 (step 86). The metal connectors 79 extend outward from the primary optic 22 and provide electrical connection with the circuit board 18 after installation onto the circuit board 18. The circuit board 18 is then installed within the housing 12 (step 88) behind the dimmable reflective element 14 or another suitable secondary optic 24, such as an external cover lens if the glare sensor assembly 16 is not disposed behind the dimmable reflective element 14, in step 90.

In another instance, an epoxy that is used to form the primary optic 22 of the glare sensor assembly 16 is prepared as one part. An epoxy resin, curing agent, and additives are mixed together along with the IR blocking material and b-staged. Stated differently, the epoxy resin, curing agent, and additives are mixed together, along with the IR blocking material, and then partially cured. At the partial curing stage, the curing is stopped to a stable, yet storable, form. Thus, IR blocking is dispersed into this mixture during preparation. The finished IR blocking epoxy mixture 78 that is used to form the primary optic 22 component is then transfer molded (melt, molded, partially cured, etc.) to form the primary optic 22 for the light sensor 20. The primary optic 22 for the light sensor 20 is then demolded and cured further to reach the desired physical properties required for use in the glare sensor assembly 16.

In still another instance, the light receiving lens 65 may be coated with an IR blocking dye film that blocks nearly all infrared light from penetrating through to the light sensor 20.

It will be understood by one having ordinary skill in the art that construction of the described disclosure and other components is not limited to any specific material. Other exemplary embodiments of the disclosure disclosed herein may be formed from a wide variety of materials, unless described otherwise herein.

According to an aspect of the present disclosure, a rearview assembly includes a housing with a dimmable reflective element and a glare sensor assembly. The glare sensor assembly includes a circuit board disposed within the housing, a light sensor in communication with the circuit board, and a primary optic proximate to and in communication with the light sensor. The primary optic is a substantially homogeneous cured epoxy that has an infrared blocker dye with a green tint that at least partially blocks infrared light from being exposed to the light sensor. A secondary optic is configured to receive and direct light to the primary optic. The primary optic is disposed between the circuit board and the secondary optic.

According to another aspect of the present disclosure, at least a portion of a primary optic extends through a circuit board.

According to still another aspect of the present disclosure, an infrared blocker dye blocks between 99% and 99.99% of infrared light.

According to another aspect of the present disclosure, a glare sensor assembly is disposed behind an electro-optic assembly.

According to yet another aspect of the present disclosure, a secondary optic includes a substantially colorless body.

According to another aspect of the present disclosure, a secondary optic includes arms configured to snap-fit engage with a circuit board.

According to another aspect of the present disclosure, a primary optic and a secondary optic are in abutting contact.

According to still another aspect of the disclosure, a secondary optic includes a fluted front surface configured to receive light.

According to another aspect of the present disclosure, a rearview assembly includes a housing with a dimmable reflective element and a glare sensor assembly. The glare sensor assembly includes a circuit board disposed within the housing, a light sensor in communication with the circuit board, and a primary optic proximate to and in communication with the light sensor. The primary optic is a substantially homogeneous cured epoxy that at least partially blocks infrared light from being exposed to the light sensor. A secondary optic is configured to receive and direct light to the primary optic.

According to still another aspect of the present disclosure, a primary optic attaches to a rear surface of a circuit board. At least a portion of the primary optic extends through the circuit board.

According to yet another aspect of the present disclosure, light with a wavelength between 800 nm and 1,000 nm is substantially blocked by a primary optic.

According to still another aspect of the present disclosure, light with a wavelength between 400 nm and 700 nm is not substantially blocked by a primary optic.

According to another aspect of the present disclosure, rearview assembly includes a housing, a circuit board disposed within the housing, and a glare sensor assembly disposed within the housing. The glare sensor assembly includes a light sensor in communication with the circuit board and an optic in communication with the light sensor. The optic is formed from an infrared blocker dye and a cured epoxy.

According to another aspect of the present disclosure, an infrared blocker dye blocks infrared light.

According to still another aspect of the present disclosure, an optic includes a primary optic proximate to and in communication with a light sensor and a secondary optic configured to receive and direct light to the primary optic.

According to another aspect of the present disclosure, a primary optic and a secondary optic are integrally molded together.

According to still another aspect of the present disclosure, a glare sensor assembly provides light input to a light sensor which is in communication with an interior cabin monitoring system.

According to yet another aspect of the present disclosure, a primary optic is a substantially homogeneous cured epoxy.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A rearview assembly, comprising:
a housing including a dimmable reflective element and a glare sensor assembly, the glare sensor assembly including:
a circuit board disposed within the housing;
a light sensor in communication with the circuit board; and
a primary optic proximate to and in communication with the light sensor, wherein the primary optic is a substantially homogeneous cured epoxy having an infrared blocker dye with a green tint that at least partially blocks infrared light from being exposed to the light sensor; and
a secondary optic configured to receive and direct light to the primary optic, wherein the primary optic is disposed between the circuit board and the secondary optic.

2. The rearview assembly of claim 1, wherein at least a portion of the primary optic extends through the circuit board.

3. The rearview assembly of claim 1, wherein the infrared blocker dye blocks between 99% and 99.99% of infrared light.

4. The rearview assembly of claim 1, wherein the glare sensor assembly is disposed behind an electro-optic assembly.

5. The rearview assembly of claim 1, wherein the secondary optic includes a substantially colorless body.

6. The rearview assembly of claim 1, wherein the secondary optic includes arms configured to snap-fit engage with the circuit board.

7. The rearview assembly of claim 1, wherein the primary optic and the secondary optic are in abutting contact.

8. The rearview assembly of claim 1, wherein the secondary optic includes a fluted front surface configured to receive light.

9. A rearview assembly, comprising:
a housing including a dimmable reflective element and a glare sensor assembly, the glare sensor assembly including:
a circuit board disposed within the housing;
a light sensor in communication with the circuit board; and
a primary optic proximate to and in communication with the light sensor, wherein the primary optic is a substantially homogeneous cured epoxy that at least partially blocks infrared light from being exposed to the light sensor; and
a secondary optic configured to receive and direct light to the primary optic.

10. The rearview assembly of claim 9, wherein the primary optic attaches to a rear surface of the circuit board, and wherein at least a portion of the primary optic extends through the circuit board.

11. The rearview assembly of claim 9, wherein light having a wavelength between 800 nm and 1,000 nm is substantially blocked by the primary optic.

12. The rearview assembly of claim 9, wherein light having a wavelength between 400 nm and 700 nm is not substantially blocked by the primary optic.

13. The rearview assembly of claim 9, wherein the secondary optic includes arms configured to snap-fit engage with the circuit board.

14. The rearview assembly of claim 9, wherein the glare sensor assembly is disposed behind an electro-optic assembly.

15. A rearview assembly, comprising:
a housing;
a circuit board disposed within the housing; and
a glare sensor assembly disposed within the housing, the glare sensor assembly including:
a light sensor in communication with the circuit board; and
an optic in communication with the light sensor, wherein the optic is formed from an infrared blocker dye and a cured epoxy.

16. The rearview assembly of claim 15, wherein the infrared blocker dye blocks infrared light.

17. The rearview assembly of claim 15, wherein the optic includes a primary optic proximate to and in communication with the light sensor and a secondary optic configured to receive and direct light to the primary optic.

18. The rearview assembly of claim 17, wherein the primary optic and the secondary optic are integrally molded together.

19. The rearview assembly of claim 15, wherein the glare sensor assembly provides light input to the light sensor which is in communication with an interior cabin monitoring system.

20. The rearview assembly of claim 17, wherein the primary optic is a substantially homogeneous cured epoxy.
